(19) United States
(12) Patent Application Publication
(10) Pub. No.: US 2002/0078369 A1
(43) Pub. Date: Jun. 20, 2002

(54) Method and system for providing territory control in a computer system

(76) Inventors: Michael C. Lewis, San Jose, CA (US); Bob Gardyne, Oakland, CA (US)

Correspondence Address: SAWYER LAW GROUP LLP, P O BOX 51418, PALO ALTO, CA, 94303, US

(21) Appl. No.: 09/908,680

(22) Filed: Jul. 18, 2001

Related U.S. Application Data
(60) Provisional application No. 60/221,681, filed on Jul. 28, 2000.

(51) Int. Cl. H04L 9/32

(52) U.S. Cl. 713/200

(57) ABSTRACT

A method and system for providing territory control in a computer system is disclosed. In one aspect, the method and system include allowing a signal capable of including a first signal and a second signal to be received. The first signal includes a first portion and a second portion that is interspersed with the first portion. The second signal determines how the second portion is interspersed with the first portion. The method and system also include checking the first portion of the first signal to determine if the first portion corresponds to a key, continuing normal operation of the computer system if the first portion corresponds to the key and taking an action if the first portion does not correspond to the key. In another aspect, the computer system uses a data medium. In this aspect, the method and system include using the data medium to provide a first key and a signal capable of including a first and a second signal. The first signal includes a first portion and a second portion interspersed with the first portion. The first portion includes the first key. The second signal determines how the second portion is interspersed with the first portion. The method and system also include sending the signal from the data medium. The signal can be received by the computer system, the first portion of the first signal can be compared to a second key and if the first portion of the signal does not correspond to the second key, an action can be taken by the computer system.

### FIELD OF THE INVENTION

The present invention relates to computer systems, particularly computer graphics systems, and more particularly to a method and system for providing territory control that can protect the computer system against unauthorized use.

### BACKGROUND OF THE INVENTION

Currently, computer systems are used for a variety of purposes. Computer graphics systems, in particular, are often used with software store on data media. Makers of the software or the computer systems often wish to control subsequent use of the data media or computer system. For example, data media made for sale in one country, or territory, are desired to be used only with computer systems made for that territory. The makers of data media or computer systems may desire this feature in order to better determine where their inventory is being sold or to prevent users from using potentially cheaper data media from another territory. Thus, it is desirable to prevent users from purchasing a data medium in a second territory, or copying the data medium from the second territory, and using the second territory data medium with the computer system for the first territory. More generally, the feature can be described as preventing the unauthorized use of disks, data media, or software with a computer system, particularly a computer graphics or gaming system. This feature is known as territory control.

Typically, conventional computer systems provide territory control by using two-way communication. FIG. 1 depicts a conventional method 10 which conventional computer systems may use to prevent unauthorized use of software or hardware. A user of the system types in a password, via step 12. In some cases, the password is provided multiple times. The computer system then encrypts the password, via step 14. The computer system then sends the encoded password to the software, for example to the data medium, via step 16. It is then determined whether the encrypted password provided by the user matches a stored password, via step 18. Typically, step 18 includes either decrypting the user-provided password or encrypting the stored password. If the passwords match, then the user is allowed to use the software, via step 20. If, however, the passwords do not match, then the user is not allowed to use the software, via step 22. Thus, unauthorized users can be prevented from using software or hardware.

Often, unauthorized use is desired to be prevented without requiring user input. FIG. 2 depicts such a conventional method 50 for protecting against unauthorized use. The method uses two devices, typically a computer system such as a computer game system and a computer-readable medium, such as a data medium storing a game. The first device, such as the data medium, encrypts some string using a particular, predetermined encryption algorithm, via step 52. The data medium then sends the encrypted string to the computer system, via step 54. Typically, the string that was encrypted is also send to the computer system in step 54. It is then determined whether the string was encrypted properly, via step 56. Step 56 typically determines whether the encryption algorithm used by the data medium is the same as the encryption algorithm provided in the computer system. If the encryption algorithms do not match, then use of the data medium is prevented, via step 60. If, however, the encryption algorithms match, then use of the data medium is allowed, via step 58. Thus, a data medium that is from another territory, from another manufacturer or is otherwise unauthorized cannot be used. Consequently, territory protection can be provided. In addition, other conventional methods for protecting against unauthorized use are available. For example, the use of public keys is well known.

Although the conventional methods 10 and 50 function, one of ordinary skill in the art will readily recognize that another mechanism for providing territory protection is desired for a variety of reasons. For example, many of the encryption algorithms and mechanisms for providing territory protection are proprietary. In addition, it would be desirable if such a mechanism was both relatively simple to implement yet difficult to reverse engineer. As a result, manufacturers can provide territory protection relatively simply and easily. At the same time, difficulty in reverse engineering the territory control would help ensure that the territory protection can continue to function once the products, such as the computer system or data medium, are released to the public.

Accordingly, what is needed is a system and method for providing territory control. The present invention addresses such a need.

### SUMMARY OF THE INVENTION

The present invention provides a method and system for providing territory control in a computer system. In one aspect, the method and system comprise allowing a signal capable of including a first signal and a second signal to be received. The first signal includes a first portion and a second portion that is interspersed with the first portion. The second signal determines how the second portion is interspersed with the first portion. The method and system also comprise checking the first portion of the first signal to determine if the first portion corresponds to a key, continuing normal operation of the computer system if the first portion corresponds to the key and taking an action if the first portion does not correspond to the key. In another aspect, the computer system uses a data medium. In this aspect, the method and system include using the data medium to provide a first key and a signal capable of including a first signal and a second signal. The first signal includes a first portion and a second portion interspersed with the first portion. The first portion includes the first key. The second signal determines how the second portion is interspersed with the first portion. The method and system also comprise sending the signal from the data medium. The signal can be received by the computer system, the first portion of the first signal can be compared to a second key and if the first portion of the signal does not correspond to the second key, an action can be taken by the computer system.

According to the system and method disclosed herein, the present invention provides territory control and can prevent unauthorized use of data media with the computer system in a manner that is relatively simple, yet difficult to reverse engineer.

### BRIEF DESCRIPTION OF THE DRAWINGS

FIG. 1 is a flow chart of a conventional method for preventing an unauthorized user from accessing software or hardware.

FIG. 2 is a flow chart of a conventional method for preventing unauthorized use of software or hardware.

FIG. 3A is a high-level flow chart of one embodiment of a method for providing territory control in accordance with the present invention.

FIG. 3B is a diagram of the signals that can be provided using one embodiment of the method for providing territory control in accordance with the present invention.

FIG. 4 is a more detailed flow chart of one embodiment of a method for providing territory control in accordance with the present invention.

FIG. 5 is a flow chart of one embodiment of a method for providing territory control in a data medium in accordance with the present invention.

FIG. 6 is a high-level block diagram of one embodiment of a system for providing territory control in a computer system in accordance with the present invention.

FIG. 7 is a block diagram of one embodiment of a system for providing territory control in a computer system in accordance with the present invention.

FIG. 8 is a block diagram of one embodiment of a system for providing territory control in a data medium in accordance with the present invention.

FIG. 9 is a block diagram of a system for providing territory control in a computer system using a data medium in accordance with the present invention.

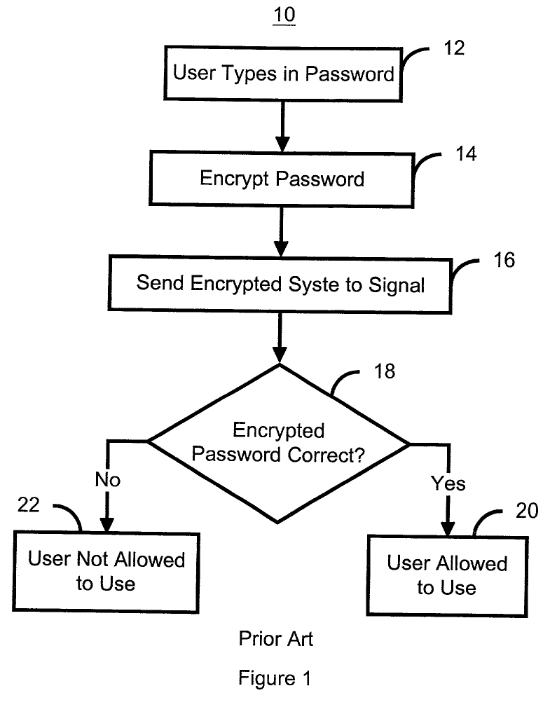

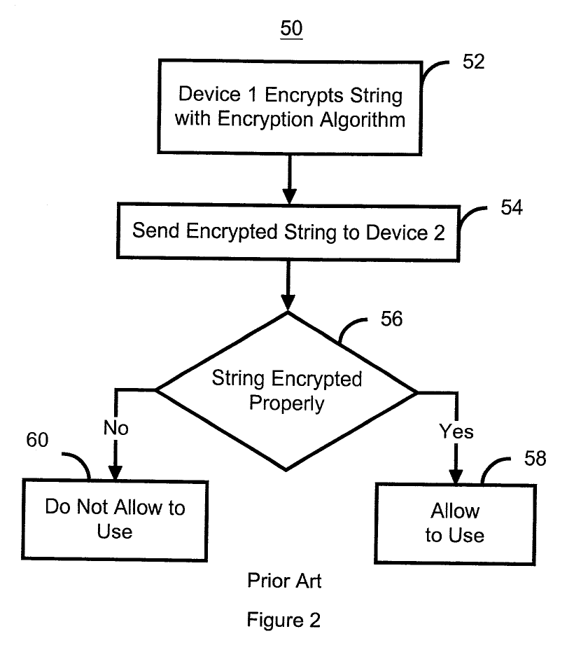

### DETAILED DESCRIPTION OF THE INVENTION

The present invention relates to an improvement in computer systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

Territory control, the ability to prevent unauthorized use, for example of software or hardware, is desirable for many reasons. Often manufacturers wish to control their inventory based on territories or otherwise preclude the use of certain items. Many conventional methods are employed to protect against unauthorized use, for example of software or hardware. Typically, these conventional methods use two way communication between a user and a device or between devices. Conventional methods typically employ some type of encryption algorithm or password and check either the algorithm or the password for correctness.

Although conventional methods function, one of ordinary skill in the art will readily realize that other methods for providing territory control are desired. It would be desirable if such methods are relatively simple to implement yet difficult to reverse engineer.

The present invention provides a method and system for providing territory control in a computer system. In one aspect, the method and system comprise allowing a signal capable of including a first signal and a second signal to be received. The first signal includes a first portion and a second portion that is interspersed with the first portion. The second signal determines how the second portion is interspersed with the first portion. The method and system also comprise checking the first portion of the first signal to determine if the first portion corresponds to a key, continuing normal operation of the computer system if the first portion corresponds to the key and taking an action if the first portion does not correspond to the key. In another aspect, the computer system uses a data medium. In this aspect, the method and system include using the data medium to provide a first key and a signal capable of including a first signal and a second signal. The first signal includes a first portion and a second portion interspersed with the first portion. The first portion includes the first key. The second signal determines how the second portion is interspersed with the first portion. The method and system also comprise sending the signal from the data medium. The signal can be received by the computer system, the first portion of the first signal can be compared to a second key and if the first portion of the signal does not correspond to the second key, an action can be taken by the computer system.

The present invention will be described in terms of particular keys and a particular mechanism for selecting keys. However, one of ordinary skill in the art will readily recognize that this method and system will operate effectively for other keys as well as for keys selected using another mechanism. The present invention will also be described in terms of a data medium, such as a game data medium. However, one of ordinary skill in the art will readily recognize that other items used with a computer system, such as a disk or CD-ROM, are consistent with the present invention. Consequently, as used herein, data medium could include other mechanisms for utilizing software on a computer system.

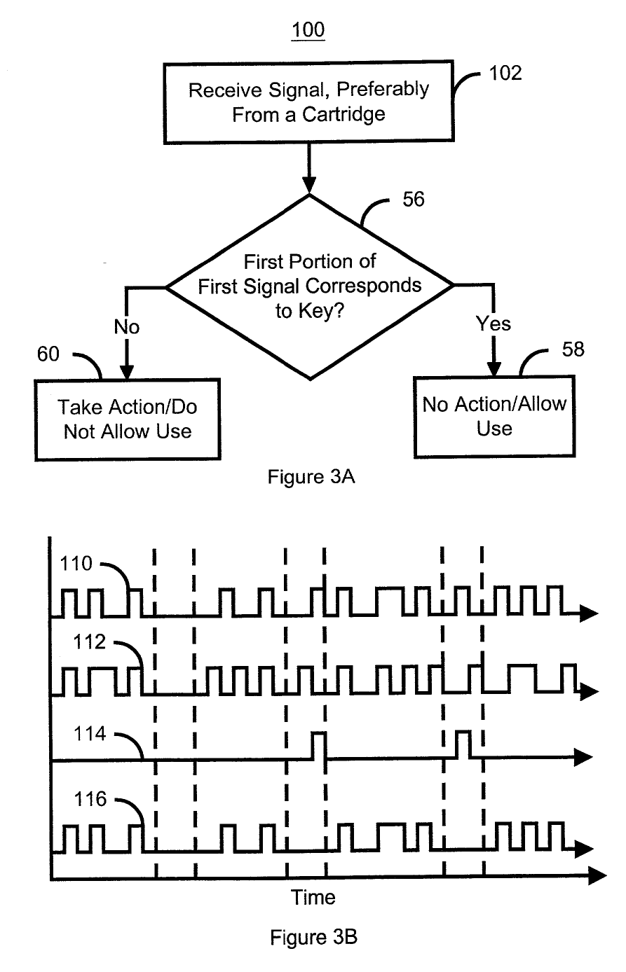

To more particularly illustrate the method and system in accordance with the present invention, refer now to FIG. 3A, depicting one embodiment of a method 100 for providing territory control in accordance with the present invention. A signal is received, via step 102. In one embodiment, the signal includes a first signal and a second signal. The first signal includes a first portion and a second portion. The first portion of the first signal is interspersed with the second portion of the first signal. Preferably, the second portion of the signal is noise. The first signal is also repeated, thereby repeating the first and second portions of the first signal. In a preferred embodiment the first signal is long. Thus, it would be difficult for one attempting to reverse engineer the system to store the first portion of the first signal. As discussed below, the first portion of the first signal can correspond to a key. Making the first signal difficult to store thus makes it difficult to obtain the key. For example, in one embodiment, for a system operating at one megahertz, the first signal (and thus the first portion of the first signal) would take approximately two minutes to complete. Thus, one attempting to reverse engineer the system would store approximately 120 million samples in order to obtain the first portion of the first signal and, therefore, the key. The second signal preferably determines the interspersal between the first and second portions of the first signal. In a preferred embodiment, the interspersal of the first and second portions of the first signal is not fixed. In other words, the time between portions of the first signal is preferably not fixed. Also in a preferred embodiment, the second signal corresponds to a clock or count signal which need not have a fixed period. Thus, in order to accurately determine a key, an individual attempting to reverse engineer the method would actually store both the first signal and the second signal. For the system discussed above, therefore, approximately two hundred and forty million samples (one hundred and twenty million samples for each of the first and second signals) would be stored, further complicating reverse engineering.

It is determined whether the first portion of the first signal corresponds to the key, via step 104. Preferably, step 104 includes separating the first portion of the first signal from the second portion of the first signal and reading the first portion of the first signal. In a preferred embodiment, step 104 also includes determining the data in the first portion of the first signal that can corresponds to the key. Step 104 also includes comparing data in the first portion of the first signal to the key. The data in the first portion of the first signal is preferably a pattern of bits which may match the key. In a preferred embodiment, the method 100 is used to determine whether software, which may be stored on a data medium, can be used with the computer system. Thus, in a preferred embodiment, the data medium is allowed to be used with the computer system if the pattern of bits in the first portion of the first signal matches the key.

If the first portion of the first signal corresponds to the key, then no action is taken, via step 106. Thus, step 106 allows continued operation of the computer system. If the first portion of the first signal does not match the key, then an action is taken, via step 108. Thus, if the signal provided in step 102 does not provide the appropriate key, then step 108 ensures that action is taken. In a preferred embodiment, step 108 includes slowing the computer system. Preferably, the computer system is slowed sufficiently to make it effectively unusable or at least frustrating for a user. For example, in one embodiment the computer system is slowed by a factor of approximately eight to ten. In an alternate embodiment, operation of the computer system may be suspended. Also in a preferred embodiment, the method 100 is repeated periodically. Thus, as the first signal is repeated, the method 100 again checks to determine whether the first portion of the first signal corresponds to a key.

FIG. 3B is a graph depicting the signal that can be used in the method 100. The first signal 110 and the second signal 112 are depicted. In addition, FIG. 3B depicts the first portion 114 and the second portion 116 into which the first signal 110 can be decomposed. The first portion and the second portion of the first signal 110 are separated by dotted lines. Thus, as depicted in FIG. 3B, the first portion 114 of the first signal 110 is interspersed with the second portion 116. In other words, the parts where the first portion 114 holds data are interspersed with parts of the second portion 116 which hold information. However, in a preferred embodiment, only the parts of the first portion 114 that hold data are important for determining whether the computer system can continue normal operation. Thus, in a preferred embodiment, the parts of the first portion 114 which hold data are compared to the key to determine whether the first portion 114 matches the key. The second portion 116 is interspersed with the first portion in order to make the parts of the first portion 114 which may correspond to the key more difficult to determine.

The parts of the first signal 110 that correspond to the data in the first portion 114 which can correspond to the key are located using the second signal 112. In other words, the second signal 112 determines how the first portion 114 of the first signal 110 is interspersed with the second portion 116 of the first signal 110. In a preferred embodiment, the first portion 114 is read each time a particular number of pulses, as measured by the number of rising edges, in the second signal 112. In a preferred embodiment, each time a particular number of pulses in the second signal 112 is counted, one bit of the first signal 110 is read. The bit read corresponds to a bit of information in the first portion 114. However, nothing prevents another number of bits from the first signal 110 from being read each time the particular number of pulses is counted. Also in a preferred embodiment, the particular number of pulses counted before reading the first signal 110 changes. Changing the number of pulses between times when the first signal 110 makes it more difficult for one attempting to reverse engineer the method 100 to determine which portion of the first signal 110 corresponds to the key. Also in a preferred embodiment, the key used changes over time. Preferably, the key used changes as the number of pulses changes.

In a preferred embodiment, the key to which data in the first portion 114 of the first signal 110 corresponds is five hundred and twelve bits in length. However, nothing prevents another number of bits from being used. Also in a preferred embodiment, the first portion 114, as well as the second portion 116 and the entirety of the first signal 110 is significantly longer. For example, in one embodiment, to transmit the entire first portion 114, the entire second portion, or the entire first signal 110, (which correspond to the entire key) approximately two minutes for a one MHz processor. As discussed above, the length of these signals helps make the system and method in accordance with the present invention more difficult to reverse engineer.

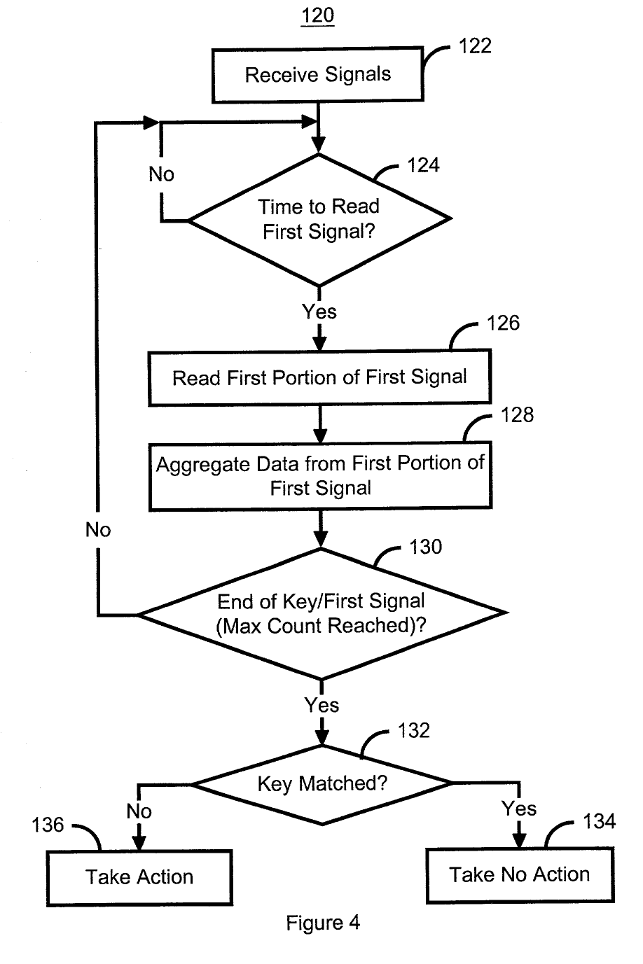

FIG. 4 is a more detailed flow chart of a method 120 for providing territory protection in accordance with the present invention. The signal is received, via step 122. The signal is preferably received by the computer system from a data medium or other software containing means. However, nothing prevents the data medium or other software containing means from receiving the signal from the computer system in step 122. Likewise, the method 120 can also be used with other hardware or software. The signal includes a first signal and a second signal, as described above with respect to FIGS. 3A and 3B. Referring back to FIG. 4, the first signal includes a first portion, which can contain data corresponding to a key, and a second portion, which is used to provide spurious data in order to make the first portion more difficult to read. The second signal determines the interspersal between the first portion and the second portion of the first signal. In other words, the second signal determines when the first signal should be read in order to read data in the first portion of the first signal.

It is determined whether the first signal should be read using the second signal, via step 124. In one embodiment, step 124 is performed by counting the number of pulses in the second signal and determining whether the number of pulses has reached a particular number. If the count for the pulses has reached the particular number, then it is time to read the first signal. Note that the pulses of the second signal need not be of equal length or equally spaced apart in time. If it is not time to read the first signal, then the step 124 is repeated until it is time to read the first signal for data. Once it is determined that the first signal is to be read, then the first signal is read for a particular amount of time, via step 126. In a preferred embodiment, step 126 reads a single bit of information from the first signal. This single bit of information is the data in the first portion of the first signal that may correspond to the key. However, in an alternate embodiment, multiple bits of data can be read in step 126.

The data read from the first signal (i.e. data in the first portion of the first signal) is accumulated, via step 128. In a preferred embodiment, step 128 includes performing a checksum on the data and storing the result of the checksum. A checksum is preferably used in order to reduce the amount of data that must be stored. The amount of data stored is desired to be reduced because the first portion of the first signal, as well as the key, are preferably quite long. The preferred key is five hundred and twelve bits long. The length of the first signal, and thus the first portion of the first signal, is long in order to make the method 120 more difficult to reverse engineer. In a preferred embodiment, the first portion of the first signal and the first signal itself takes approximately two minutes to receive for a one MHz system. The first portion of the first signal, and thus the first signal, is preferably repeated only every two minutes. As a result, one attempting to reverse engineer the method 100 would have to store an extremely large number of samples. The number of samples is further increased because the second signal would also probably be stored. However, because a checksum is used, a system which uses the method 120 could store a much smaller amount of data than either the first portion of the first signal or the key. However, nothing prevents the method 120 from storing the entire first portion of the signal, the entire key, or from using another method for reducing the amount of data stored.

It is then determined whether the end of the first signal has been reached, via step 130. In one embodiment, step 130 is performed by determining whether a maximum number of pulses have been counted for the second signal. The maximum number of pulses of the second signal determines whether the entire key may have been received from the first signal. The maximum number of pulses for the second signal can also change. In another embodiment, step 130 is performed by determining whether a particular amount of data has been read. For example, step 130 could be performed by determining whether five hundred and twelve bits of data have been read in step 124.

If the end of the first signal has been reached, then it is determined whether the accumulated data from the first portion of the first signal matches the key, via step 132. If the accumulated data does not match the key, then an action is taken to prevent the system from operating normally, via step 134. Thus, if the signal provided in step 122 does not provide the appropriate key, then step 134 ensures that action is taken. If, however, the accumulated data matches the key, no action is taken and the system is allowed to operate normally, via step 136. In a preferred embodiment, the action that is taken in step 134 slows the operation of the computer system. In one embodiment, step 134 suspends operation of the cache for the computer system in order to slow the computer system. In another embodiment, step 134 may slow operation of the three-dimensional core used in graphics processing or slows operation of the memory controller, thereby slowing operation of the computer system. In another embodiment, step 136 may suspend operation of the computer system.

Preferably, the method 120 repeats each time the first signal is repeated. Thus, the method 120 would periodically check to determine whether operation of the computer system should continue. In a preferred embodiment, the number of pulses that determines when the first signal should be read in step 114 and the maximum number of pulses that can be used to determine whether the end of the first signal may have been reached in step 130 can change when the method 120 repeats. Also in a preferred embodiment, the key can change each time the first signal is repeated.

The methods 100 and 120 thus provide territory control. Moreover, the methods 100 and 120 intersperse data that may correspond to a key (a first portion of the first signal) with data that can be unrelated to the key (the second portion of the first signal). In addition, the methods 100 and 120 may use a second signal to determine which part of the first signal can correspond to the key. The methods 100 and 120 also use a relatively long first signal that is thus difficult to store. Furthermore, the interspersal of the first and second portions of the signal as well as the key itself may change. The above-mentioned features combine to make the methods 100 and 120 relatively difficult to reverse engineer. This is accomplished without having to encrypt the key or other data. Consequently, although relatively simple and inexpensive to implement, the methods 100 and 120 provide territory control that is difficult to reverse engineer.

Furthermore, in embodiments of the methods 100 and 120 which slow the operation of the computer system, for example by a factor of eight or ten, the methods 100 and 120 can be used in low performance devices without territory control. Thus, in devices where performance is not important, but the same hardware is desired to be used without territory protection, the methods 100 and 120 need not adversely affect operation of the low performance devices. Because the methods 100 and 120 may only slow operation of the computer system and because speed is not important to some applications, the hardware, discussed below, for implementing the methods 100 and 120 may be used in both low performance (slow) devices without territory control and higher performance devices with territory control. Consequently, a manufacturer need not provide different hardware for devices having different applications. For example, suppose the computer system is a portable game system. A manufacturer may wish to provide territory protection for newer games which require higher speeds for the computer system. The manufacturer can do so using the methods 100 and 120. At the same time, older games which do not require high computer system speeds and for which territory protection is not desired can still be run on the computer system. This is because embodiments of the methods 100 and 120 may act to slow the computer system when the proper key is not received. However, the amount by which the embodiments of the methods 100 and 120 slow the computer system may be sufficient to make use of the newer games frustrating to users and difficult, yet may not be sufficient to make use of the older games difficult or frustrating. Thus, the same hardware can be used for both old and new games, some of which have territory control and some of which do not.

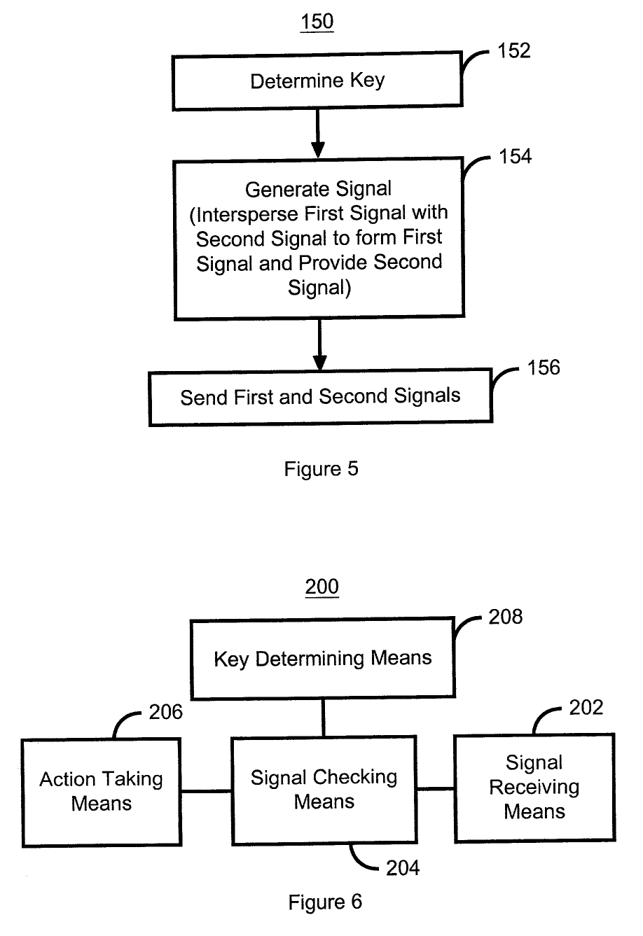

The keys that may be used in the methods 100 and 120 may also be selected in a variety of ways. FIG. 5 depicts one embodiment of a method 150 for providing the key and sending the first signal such that the computer system can be used. The key is determined, via step 152. In a preferred embodiment, the key is five hundred and twelve bits long. Also in a preferred embodiment, there are sixteen possible keys. Preferably, a five hundred and twelve bit pattern is broken into sixteen different thirty-two bit sections. In such an embodiment, the key is determined in step 152 by determining which of the thirty-two bits sections corresponds to the first part of the key. The remaining sections make up the remaining portion of the key, preferably by placing the remaining sections in order. For example, presume that the thirty-two bit sections are labeled zero through fifteen. A key of the sixteen possible keys is determined by selecting one of the sections zero through fifteen. For example, suppose the fourth key is selected. Thus, the thirty-two bit section labeled three will be selected to be first. Preferably, the remaining portion of the key is formed by sections four, five, six, seven, eight, nine, ten, eleven, twelve, thirteen, fourteen, fifteen, zero, one and two, in order. Also in a preferred embodiment, the key changes each time the first signal is repeated. Thus, if the key initially started with section three of the pattern, then the next time the first signal is repeated, then the key commences with section four of the pattern. Thus, the key can change.

The first signal is generated by interspersing the currently selected key with the noise, via step 154. Thus, step 154 forms the first portion and the second portion of the first signal and combines these portions to form the first signal. The first and second portions are combined using a second signal. In a preferred embodiment, one bit of the key is provided every N pulses in the second signal. However, in another embodiment, another number of bits of the key can be provided every N pulses. While N pulses are being counted, the second portion of the second signal provides preferably unrelated and random data. In a preferred embodiment, the number of pulses, N, is given by the equation:

N=P*7+8191

Where

P=[0,15]

Also in a preferred embodiment, P is initially selected by the section of the pattern chosen to be the first section of the key in step 152. For example, as discussed above, if section three of the pattern is selected, then P will initially be three. Also in a preferred embodiment, the value of P changes periodically. In one embodiment, P may cycle through the values zero through fifteen in order. For example, if P starts at three, then P will be four, five, six, and so on in order. In a preferred embodiment, P changes each time the first signal is repeated. Thus, in a preferred embodiment, P changes each time the method 100 or 120 repeats or, in one embodiment of the method 120, each time the maximum number of pulses of the second signal is counted. The first and second signals are then sent, via step 156. In one embodiment, step 156 sends signals to the computer system, for example from a data medium or other component. In another embodiment, the signal is sent from the computer system.

Thus, the method 150 can be used to select a particular key from a number of keys. The particular key may be selected based on a geographic territory or other mechanism. Thus, using the methods 150 in conjunction with the methods 100 and 120 different keys may be used to provide territory protection. In addition, the methods 150 in conjunction with the methods 100 and 120, reverse engineering of the system may be made more difficult by changing the time, or number of pulses, between portions of the key.

The methods 100, 120 and 150 may be used in conjunction with a variety of systems. FIG. 6 depicts one embodiment of a system 200 for providing territory control in accordance with the present invention. In a preferred embodiment, the system 200 is built into the computer system. However, nothing prevents the system 200 from being in a data medium or other piece of hardware or could be otherwise removable from the computer system. The system 200 preferably implements the method 100 or 120.

The system 200 includes means for receiving a signal 202, means for checking the signal against a key 204, means for taking an action 206 based on the result of the check of the signal and, in one embodiment, means for determining the key 208. The means for receiving the signal 202 preferably include a port, a line or some other mechanism for having a signal input to the system 200. The checking means 204 determine whether the received signal corresponds to the key. The key is provided by the key determining means 208. In one embodiment, the key determining means 208 simply store the key for the system 200. In another embodiment, the key determining means 208 can store multiple keys and select one or more of the multiple keys. The action taking means 206 allows the computer system of which the system 200 is a part to take an action based on whether or not the signal received corresponds to the key. In a preferred embodiment, the action taking means 206 merely asserts or does not assert a valid signal. Based on this valid signal, the computer system may slow, suspend operation, or take another action.

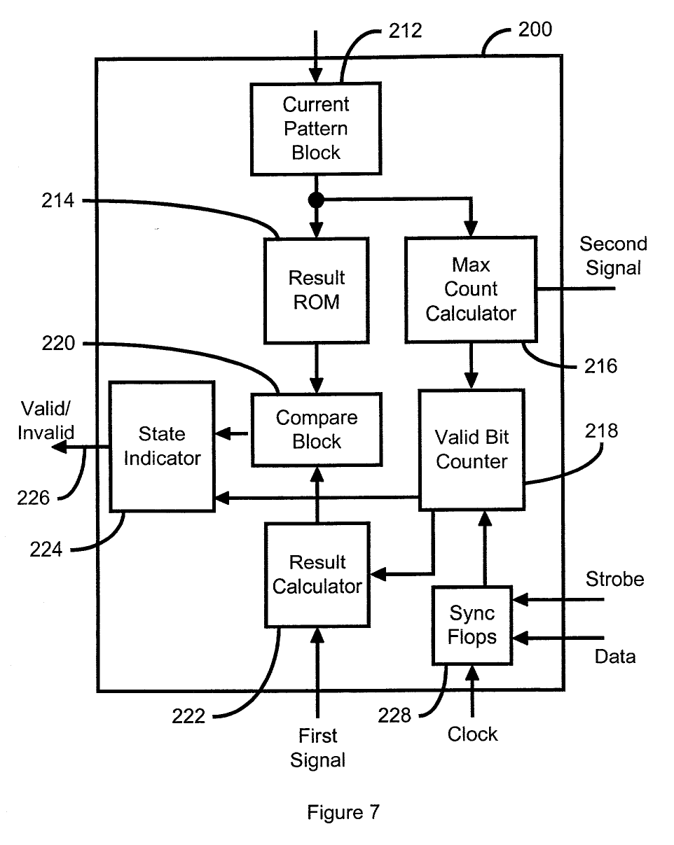

FIG. 7 depicts a more detailed block diagram of the system 200. The system 200 includes current pattern block 212, a result read only memory (ROM) 214, a max count calculator 216, a valid bit counter 218, a compare block 220, a result calculator 222, a state indicator 224, a signal output 226 and a set of sync flops 228. The current pattern block 212 receives a signal, preferably from a bus. The signal determines which of the possible keys is the appropriate key for the system 200. In a preferred embodiment, the signal received includes four bits. Based on the combination of four bits, a single key of a possible sixteen keys is determined by the current pattern block 212. As discussed above, this is preferably accomplished by decoding the four bits and selecting a particular section of sixteen sections of a pattern with which the key commences. Also in a preferred embodiment, this is accomplished by indicating which pattern, P, of sixteen possible is to be used. Thus, the current pattern block 212 preferably selects the initial pattern, P, based on the signal. Also in a preferred embodiment, the current pattern block 212 cycles through the possible patterns by changing the pattern each time the first signal is completely received.

Selection of the pattern, P, preferably determines the key and the number of pulses, N, of the second signal between which the first portion of the first signal is read. Consequently, the current pattern block 212 is coupled with the result ROM 214 and the max count calculator 216. The result ROM 214 stores data which corresponds to each of the possible keys. Thus, the current pattern block 212 transmits to the result ROM 214 the pattern, P, which relates to the key to be currently selected. Thus, a four-bit signal is preferably provided to the result ROM 214. The result ROM 214 will output the data corresponding to the key currently selected. In a preferred embodiment, this data is a checksum for the current key corresponding to the current pattern. In an alternate embodiment, the result ROM 214 stores all the possible keys. In such an embodiment, the data provided by the result ROM 214 is a current key that is selected based on the current pattern. The data is provided from the result ROM 214 to the compare block 220 for use in comparing the first signal to the key.

The current pattern block 212 is coupled with and transmits the pattern, P, to the max count calculator 216. Thus, a four-bit signal is preferably provided to the max count calculator 216. The max count calculator 216 uses the pattern, P, to determine the number of counts, N, of the second signal which will indicate that the first signal is to be read. The max count calculator 216 also receives the second signal and counts the pulses of the second signal. When the count reaches N, the max count calculator provides a signal to the valid bit counter 218. In one embodiment, the max count calculator 216 also indicates when the maximum number of counts has been reached to indicate when the first signal has finished transmission and all of the key has been received. However, in another embodiment, the valid bit counter 218 or the result calculator 222 determines when all of the key has been received.

The result calculator 222 receives the first signal. The valid bit counter 218 provides a valid bit signal to the result calculator 222 when it is time to read the first portion of the first signal. In a preferred embodiment, the result calculator will read only a single bit. However, nothing prevents the result calculator 222 from reading another number of bits. In a preferred embodiment, the result calculator 222 also generates a checksum from the data read from the first signal. However, nothing prevents the result calculator 222 from merely storing a key or some portion of the key or from generating another function of the key. When the result calculator 222 has read a particular amount of data, preferably five hundred and twelve bits, the result calculator 222 provides a resultant to the compare block 220. Preferably, the valid bit counter 218 determines when the particular amount of data has been read by counting the number of valid bits and providing a signal to the result calculator. However, nothing prevents the use of another mechanism for making this determination. The resultant is preferably the checksum of the key. In one embodiment, the result calculator 222 provides the resultant to the compare block 220 when the valid bit counter 218 indicates that this function should be performed. In another embodiment, the result calculator 222 determines when to provide the resultant to the compare block 220, for example by determining the number of calculations performed, by determining the number of valid bit signals received, or by counting a total number of pulses of the second signal which have been received by the system 200.

The resultant received from the result calculator 222 and the stored data corresponding to the key received from the result ROM 214 are compared by the compare block 220. Based on the results of this comparison, a signal is sent to the state indicator 224. The state indicator 224 indicates that a valid state if the resultant matches the data corresponding to the key. The state indicator 224 indicates that an invalid state exists if the resultant does not match the data corresponding to the key. A valid/invalid signal is then provided over signal output 226. The signal output 226 is coupled with some portion of the computer system in which the system 200 resides. For example, the signal output 226 could be coupled to the cache of the microprocessor for the computer system. If the signal output 226 carries a valid signal, caching may continue. However, if the signal output 226 carries an invalid signal, caching is suspended. As a result, operation of the computer system is slowed. Thus, the valid/invalid signal provided over the signal output allows the computer system to take action based upon whether the first portion of the first signal corresponds to the key.

In addition, the system 200 may include sync flops 228 which receive a clock signal a microcontroller strobe signal and microcontroller data from the computer system. The sync flops 228 are coupled to the valid bit counter 218. The sync flops 228 ensure that the signals are synchronized to the internal clock of the computer system. Thus, the system 200 is shielded against setup and hold violations on the inputs. For example, the computer system may run at five MHz, while the system 200 may run at one MHz. As long as the system sending the signal to the system 200 runs at least twice the speed of the system 200, the sync flops 228 can ensure that the system 200 is synchronized. In another embodiment, however, the sync flops 228 can be omitted and the external clock of the device, such as a data medium, can be used.

The system 200 may also provide a reset signal. The reset signal is used to ensure that the system 200 operates properly in the event of a glitch. The resent signal is discussed below with respect to FIG. 9.

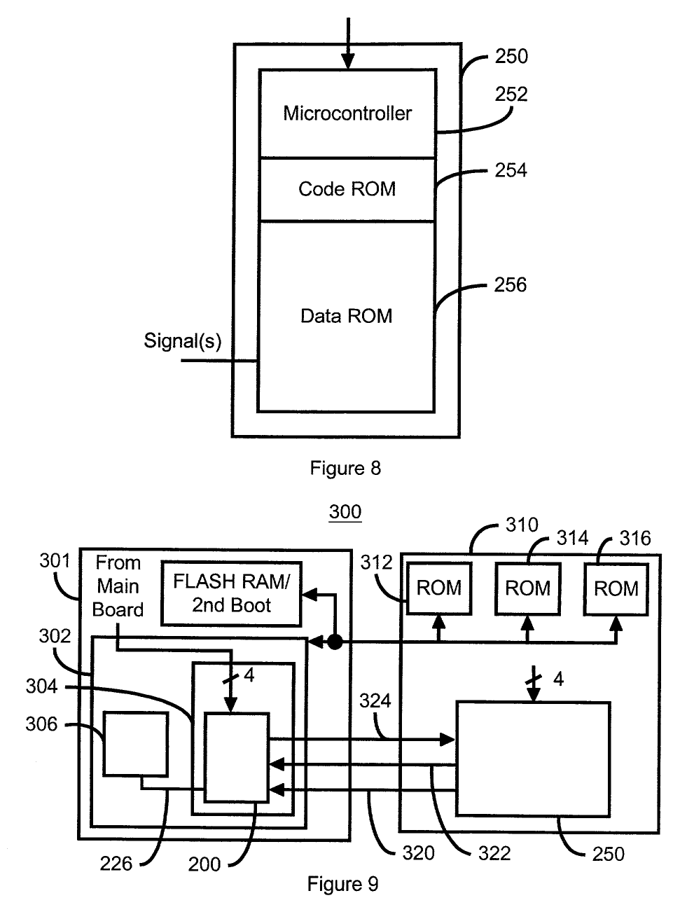

FIG. 8 depicts one embodiment of a system 250 for generating the first and second signals that are provided to the system 200. Thus, the systems 200 and 250 preferably function together to provide territory control. However, the system 200 could be used with another mechanism for generating the first and second signals. Similarly, the system 250 could be used with another system for determining whether the first portion of the first signal matches the key. The system 250 preferably resides in a data medium to be used with the computer system in which the system 200 preferably resides. However, nothing prevents the systems 200 and 250 from residing elsewhere. For example, the system 200 may reside in the data medium, while the system 250 resides in the computer system. However, because of the more complicated tasks performed by the system 200, this would make the data medium more expensive.

The system 250 includes a microcontroller 252, a code ROM 254, and a data ROM 256. The system 250 outputs the first and second signals and can receive a reset signal. The microcontroller 252 receives a signal which indicates the key to be selected. Preferably, the signal includes four bits and determines which of sixteen keys is to be selected. In a preferred embodiment, the four-bit signal used for the system 200 is different from the four-bit signal used for the system 250. For example, if in the system 200 bits 0000 determine that section zero of sixteen possible sections (sections zero through fifteen) of a pattern is the first part of the key, then in the system 250 bits 0000 determine that the key should commence with another section of the pattern. Thus, value of the four-bit signal used in the system 200 is preferably different from the value of the four-bit signal used in the system 250 when the systems 200 and 250 are to be used with the same key. This makes the systems 200 and 250 more difficult to reverse engineer. However, nothing prevents the same four-bit signal from being used with both system 200 and system 250.

The data ROM 256 holds the pattern used for the key. Thus, based upon the signal received by the microcontroller 252, different keys may be selected from the data ROM 256. Preferably, the data ROM 256 holds sixteen different sections of the key. The order of the sections as found in the key is determined by the microcontroller 252 based on the signal received. Using the code stored in code ROM 254 and the microcontroller 254, the bits of the key are interspersed with preferably random data. Thus, the first signal is generated. Using the microcontroller 254, the code ROM 254, and the data ROM 256, the second signal is also generated. The first and second signals are sent by the system 250.

FIG. 9 depicts one embodiment of a system 300 which utilizes the system 200 and the system 250. The system 300 includes a computer system 301 that is coupled with a data medium 310. For clarity, only portions of the computer system 301 and the data medium 310 are depicted. The computer system 301 includes a core 302. The system 200 preferably resides in this core 302 in a memory controller 306. However, nothing prevents the system 200 from residing elsewhere. The core 302 also includes a main central processing unit (CPU) 304. Preferably, the system 200 is coupled with the main CPU 304. In a preferred embodiment, the system 200 provides the valid/invalid signal to the main CPU 304 via signal output 226. Also in a preferred embodiment, the valid/invalid signal is provided to the cache (not explicitly shown) for the main CPU 304 to control caching. However, nothing prevents the valid/invalid signal from being provided to another component to control other operations. For example, the valid/invalid signal provided over the signal output 226 could be coupled to the memory controller 306 to controller the speed of memory accesses. Similarly, the valid/invalid signal provided over the signal output 226 could be coupled to a three-dimensional graphics core (not explicitly shown) to control the speed of the three-dimensional core. Thus, the speed of the computer system 301 can be controlled by the system 200. In addition, a signal, preferably four bits in length, is provided to the system 200 in order to select the pattern, as discussed above. Preferably, the four-bit signal is provided by a main board (not shown).

The four-bit signals are preferably provided to the systems 200 and 250 by using bond-out options for connecting the system 200 and 250 to the computer system 301 and the data medium 310, respectively. Thus, four wires are preferably used for each of the systems 200 and 250. Based on the combination of wires that are connected, different keys and patterns, P, may be selected. The signals are preferably provided in this manner because the bond-out options are generally inaccessible to a user. A user may thus be required to more thoroughly investigate the computer system 301 or the data medium 310 in order to determine the combination of bits used to select the key in the computer system 301 or the data medium 310. The computer system 301 or the data medium 310 may be rendered unusable by such an investigation. Consequently, reverse engineering of the systems 200 and 250 may be made more expensive and thus more difficult.

The data medium 310 includes three ROMs 312, 314 and 316 to which the memory controller 306 is coupled. The data medium 310 also includes the system 250. The system 250 is coupled with the system 200. The system 250 is also provided with a signal, preferably four bits in length, that is used to select the key. The first and second signals are provided from the system 250 to the system 200 via lines 320 and 322.

In addition, a reset signal may be provided from the system 200 to the system 250, via line 324. The resent signal may be used in the event that the system 200 does not receive the first and second signals or operation of the system 200, the system 250, the computer system 301 or the data medium 310 is otherwise interrupted. Thus, the reset signal is used to account for glitches in operation of the system 300. The reset signal is asserted for a preferably long period of time by the system 200. The reset signal is provided to the system 250 for a preferably random number of cycles. The system 250 is thus reset. Also in a preferred embodiment, the system 200 is reset. Consequently, the system 250 and system 200 will recommence operation and, where the system 200 and 250 are meant to be used together, the same key will be selected for both the system 200 an 250. The systems 200 and 250 may also begin with the desired initial pattern, P, and the desired number of counts, N. If the data medium 310 is designed to be used with the computer system 301, the system 200 will indicate that the keys match using the methods 100 or 120. Thus, even if operation of the computer system 301 had been slowed due to some glitch in operation, such as the spurious detection of a mismatched key, the computer system 301 will resume normal operation. If, however, the data medium 310 is not designed to be used with the computer system 301, then the system 200 using the methods 100 or 120 will detect that the first portion of the first signal does not match the key. As a result, operation of the computer system 301 will continue to be slowed, suspended, or otherwise adversely affected. Thus, the system 200 and 250 can not only provide territory control using the methods 100 and 120, the systems 200 and 250 can also account for glitches which temporarily indicate that might otherwise interrupt the desired operation of the system 100.

Thus, the methods 100, 120 and 150 and the system 200 and 250 provide territory control. Territory control is provided without requiring encryption of strings or passwords. In addition, two-way communication between devices, such as the computer system and the data medium, may not be required. Furthermore, when algorithms such as checksums are used, only a relatively small amount of information may be required to be stored when providing territory control. The methods 100 and 120 use signals which take a long time to repeat and are thus difficult to store. In addition, keys used may be relatively long and interspersed with other data at preferably changing intervals. The interspersal of the keys with other data may also be dependent upon a second signal. Moreover, the keys may change during operation of the methods 100, 120 and 150 and the systems 200 and 250. Furthermore, the keys selected can depend upon the bond-out options of the system 200 and 250. Thus, the methods 100, 120 and 150 and the systems 200 and 250 may be difficult to reverse engineer. Furthermore, if two-way communication is to be allowed, a reset signal can be provided between the systems 200 and 250 to account for glitches in operation of the computer system or data medium. As a result, territory control can be provided in a relatively reliable, inexpensive and simple fashion, while reverse engineering the territory control mechanism may be difficult, frustrating and expensive. Thus, users will be encouraged to abide by the manufacturers' limitations, rather than engaging in unauthorized copying and use.

A method and system has been disclosed for providing territory control in a computer system. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing territory control in a computer system, the method comprising the steps of:
(a) allowing a signal to be received, the signal capable of including a first signal and a second signal, the first signal including a first portion and a second portion, the second portion being interspersed with the first portion, the second signal determining how the second portion is interspersed with the first portion; and
(b) checking the first portion of the first signal to determine if the first portion of the first signal corresponds to a key;
(c) continuing normal operation of the computer system if the first portion of the first signal corresponds to the key; and
(d) taking an action if the first portion of the first signal does not correspond to the key.

2. The method of claim 1 wherein the checking step (b) further includes the steps of:
(b1) reading the second signal to determine how the second portion is interspersed with the first portion;
(b2) reading the first portion of the first signal; and
(b3) determining whether data in the first portion matches the key.

3. The method of claim 1 wherein the determining step (b) further includes the steps of:
(b1) providing a first checksum of the first portion of the first signal;
(b2) comparing the first checksum with a second checksum of the key.

4. The method of claim 1 wherein the action taking step (c) further includes the step of:
(c1) slowing operation of the computer system.

5. The method of claim 4 wherein the computer system further includes a microprocessor capable of performing caching and wherein the slowing step (c1) further includes the step of:
(c1i) preventing the microprocessor from performing caching.

6. The method of claim 1 wherein the action taking step (c) further includes the step of:
(c1) suspending operation of the computer system.

7. The method of claim 1 further comprising the step of:
(e) selecting the key from a plurality of possible keys, the plurality of possible keys being determined from a pattern including a plurality of segments, each of the plurality of possible keys corresponding the plurality of segments in an order commencing with a particular segment of the plurality of segments.

8. The method of claim 1 wherein the first signal includes at least one million samples.

9. The method of claim 1 further comprising the step of:
(e) sending a reset signal if operation of the computer system is interrupted.

10. A method for providing territory control in a computer system utilizing a data medium, the method comprising the steps of:
(a) providing a first key using the data medium;
(b) providing a signal using the data medium, the signal capable of including a first signal and a second signal, the first signal including a first portion and a second portion, the first portion including the first key, the second portion being interspersed with the first portion, the second signal determining how the second portion is interspersed with the first portion
(c) sending the signal from the data medium;
wherein the signal can be received by the computer system, the first portion of the first signal can be compared to a second key by the computer system and if the first portion of the first signal does not correspond to the second key, an action can be taken by the computer system and wherein if the first portion of the signal corresponds to the second key normal operation of the computer system can be continued.

11. The method of claim 10 further comprising the step of:
(d) selecting the first key from a plurality of possible keys, the plurality of possible keys being determined from a pattern including a plurality of segments, each of the plurality of possible keys corresponding the plurality of segments in an order commencing with a particular segment of the plurality of segments.

12. The method of claim 10 wherein the first key includes at least one million samples.

13. A computer-readable medium containing a program for providing territory control in a computer system, the program including instructions for:
(a) allowing a signal to be received, the signal capable of including a first signal of and a second signal, the first signal including a first portion and a second portion, the first portion including a key, the second portion being interspersed with the first portion, the second signal determining how the second portion is interspersed with the first portion; and
(b) checking the first portion of the first signal to determine if the first portion corresponds to the key;
(c) continuing normal operation of the computer system if the first portion of the first signal corresponds to the key; and
(d) taking an action if the first portion of the first signal does not correspond to the key.

14. A computer-readable medium containing a program for providing territory control in a computer system utilizing a data medium, the program including instructions for:
(a) providing a first key using the data medium;
(b) providing a signal using the data medium, the signal capable of including a first signal and a second signal, the first signal including a first portion and a second portion, the first portion including the first key, the second portion being interspersed with the first portion, the second signal determining how the second portion is interspersed with the first portion
(c) sending the signal from the data medium;
wherein the signal can be received by the computer system, the first portion of the first signal can be compared to a second key by the computer system and if the first portion of the first signal does not correspond the second key, an action can be taken by the computer system and wherein normal operation of the computer system can be continued if the first portion of the first signal corresponds to the second key.

15. A system for providing territory control in a computer system, the system comprising:
means for receiving a signal, the signal capable of including a first signal and a second signal, the first signal including a first portion and a second portion, the second portion being interspersed with the first portion, the second signal determining how the second portion is interspersed with the first portion; and
means for checking the first portion of the first signal to determine if the first portion of the first signal corresponds to a key;
means for allowing an action to be taken if the first portion of the first signal does not correspond to the key.

16. The system of claim 15 wherein the checking means further includes the steps of:
a max count calculator for determining how the second portion is interspersed with the first portion;
a result calculating block for storing the first portion of the first signal; and
a compare unit for determining whether the first portion matches the key.

17. The system of claim 15 wherein the result calculating block further provides and stores a first checksum of the first portion of the first signal; and wherein the compare unit compares the first checksum with a second checksum of the key.

18. The system of claim 15 wherein the action allowing means further include means for asserting a valid signal only if the first portion of the signal matches the key.

19. The system of claim 18 wherein operation of the computer system slows when the valid signal is not asserted.

20. The system of claim 19 wherein the computer system further includes a microprocessor capable of performing caching, wherein the valid signal is coupled with the microprocessor and prevents the microprocessor from performing caching when not asserted.

21. The system of claim 15 wherein the action allowing means further allow operation of the computer system to be suspended when the first portion of the first signal does not match the key.

22. The system of claim 15 wherein the key is selected from a plurality of possible keys, the plurality of possible keys being determined from a pattern including a plurality of segments, each of the plurality of possible keys corresponding the plurality of segments in an order commencing with a particular segment of the plurality of segments.

23. The system of claim 22 further comprising:
a controller in a data medium used by the computer system, the controller for providing and sending the signal to the signal receiving means.

24. The system of claim 23 wherein the controller further includes:
means for selecting a second key, the second key being the first portion of the first signal, the second key being selected from a second plurality of possible keys, the second plurality of possible keys being determined from a second pattern including a second plurality of segments, each of the second plurality of possible keys corresponding the second plurality of segments in a second order commencing with a second particular segment of the second plurality of segments.

25. The system of claim 15 wherein the key includes at least one million samples.

26. The system of claim 15 further comprising:
means for determining the key.

27. The system of claim 26 wherein the key determining means further include:
a current pattern block for selecting a pattern of a plurality of possible patterns; and
a result read only memory (ROM) coupled with the current pattern block for determining the key of a plurality of possible keys based on the pattern.

28. The system of claim 15 further comprising the step of:
means for sending a reset signal if operation of the computer system is interrupted.

29. A system in a data medium for providing territory control in a computer system utilizing the data medium, the system comprising:
a processing unit in the data medium, the processing unit including
means for providing a first key;
means for providing a signal, the signal capable of including a first signal and a second signal, the first signal including a first portion and a second portion, the first portion including the first key, the second portion being interspersed with the first portion, the second signal determining how the second portion is interspersed with the first portion; and
means for sending the signal from the data medium;
wherein the signal can be received by the computer system, the first portion of the first signal can be compared to a second key by the computer system and if the first portion of the signal does not correspond to the second key, an action can be taken by the computer system.

30. The system of claim 29 wherein the first key is selected from a plurality of possible keys, the plurality of possible keys being determined from a pattern including a plurality of segments, each of the plurality of possible keys corresponding the plurality of segments in an order commencing with a particular segment of the plurality of segments.

31. The system of claim 29 wherein the first key includes at least one million samples.
